(19) United States
(12) Patent Application Publication
(10) Pub. No.: US 2007/0143199 A1
(43) Pub. Date: Jun. 21, 2007

(54) S/M FOR PROVIDING AN OPTION TO CONVERT A PORTFOLIO OF ASSETS INTO A GUARANTEED INCOME FLOW AT A FUTURE DATE

(75) Inventors: Geoffrey S. Stiff, Richmond, VA (US); James C. Templeman, Richmond, VA (US); Matthew P. Sharpe, Richmond, VA (US); William S. White, Glen Allen, VA (US); Landis Atkinson, Richmond, VA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Genworth Financial, Inc., Richmond, VA (US)

(21) Appl. No.: 11/556,396

(22) Filed: Nov. 3, 2006

Related U.S. Application Data
(60) Provisional application No. 60/732,663, filed on Nov. 3, 2005.

(51) Int. Cl. G06Q 40/00

(52) U.S. Cl. 705/36 R

(57) ABSTRACT

A system and method for providing an investor the ability to purchase an option to exchange a future value of an asset or a portfolio of assets, regardless of future performance or value, for at least one non-cash settlement instrument outcome on a future date, where the outcome of such option is contingent on (1) a payment of an option fee, and/or (2) maintaining the portfolio of assets in accordance with at least one guideline or benchmark required for the delivery of the guarantee outcome other than cash. The method comprising the steps of determining delivery of a non-cash guaranteed outcome based on an assessment of an underwriting strategy associated with an asset or portfolio of assets; and determining an option payment amount and at least one guideline required for the delivery of the non-cash guaranteed outcome.

### RELATED APPLICATION

This application claims priority to U.S. Provisional Application titled “System And Method For Providing An Option To Convert A Portfolio Of Assets Into A Guaranteed Income Flow At A Future Date,” filed Nov. 3, 2005, and assigned Ser. No. 60/732,663. The disclosure of the above provisional application is hereby incorporated by reference in its entirety.

### FIELD OF THE INVENTION

This invention relates generally to a system and method for providing financial products and services, and more particularly, to a system and method for providing an option to convert an asset or portfolio of assets into a guaranteed income flow or other settlement at a future date.

### BACKGROUND OF THE INVENTION

Various financial products exist that enable individuals to plan and prepare for retirement. However, the majority of available products, such as mutual funds, focus primarily on accumulation. Further, the majority of available products transfer performance and other risks to the investor. Generally, an investor invests in a strategy (e.g., stocks, bonds or otherwise) the investor believes will behave in a manner consistent with a perceived risk/reward profile. However, if the product does not perform as expected, it is the investor who generally bears that risk, not the financial product or issuer of the financial product.

Annuities are one such financial product that seeks to address the issue described above by providing certain guarantees and assurances to an investor. Fixed deferred annuities, for example, may guarantee a certain future income stream in return for a current investment or deposit. In this instance, an investor may transfer performance risk to the issuer of the fixed deferred annuity. However, this strategy may involve unsatisfactory investor commitments, such as an inability to easily and with impunity terminate the strategy.

Thus, there is a need for an investment product (or structure) that allows an investor an unencumbered ability to exchange an unknown future value of a portfolio of assets for a known guaranteed investment stream on a known future date.

### SUMMARY OF THE INVENTION

According to an embodiment of the systems and methods claimed herein, a method is disclosed for providing an investor the ability to purchase an option to exchange a future value (which may be known or unknown) of an asset or a portfolio of assets, regardless of future performance or value, for at least one non-cash settlement instrument outcome on a future date, where the outcome of such option is contingent on (1) a payment of an option fee, and/or (2) maintaining the portfolio of assets in accordance with at least one guideline or benchmark required for the delivery of the non-cash guarantee outcome. The method comprising the steps of: determining delivery of a non-cash guaranteed outcome based on an assessment of an underwriting strategy associated with an asset or portfolio of assets; and determining an option payment amount and at least one guideline required for the delivery of the non-cash guaranteed outcome.

In another embodiment of the systems and methods claimed herein, a method for providing an option to exchange a future value of a portfolio of assets, regardless of future performance or value, for at least one non-cash settlement instrument outcome on a future date is provided. The method comprising: assessing an existing portfolio; assessing an underwriting strategy associated with the portfolio; determining delivery of a non-cash guaranteed outcome based on the portfolio and underwriting assessments; issuing an option to exchange a future value of the portfolio, regardless of future performance or value, for at least one non-cash settlement instrument outcome on a future date; collecting an option payment; and auditing the investment strategy of the of portfolio.

In still another embodiment of the systems and methods claimed herein, a method for providing an option to exchange a future value of a portfolio of assets, regardless of future performance or value, for at least one non-cash settlement instrument outcome on a future date is provided. The method comprising: determining delivery of a non-cash guaranteed outcome based on an existing portfolio and an underwriting strategy associated with the portfolio; determining an option payment amount and minimum strategy guidelines required for the guaranteed delivery of outcome other than cash to remain in effect; adjust and cumulate the guarantee; and deliver the appropriate guarantee.

In yet another embodiment of the systems and methods claimed herein, a system is disclosed for providing an investor the ability to purchase an option to exchange a future value of an asset or a portfolio of assets, regardless of future performance or value, for at least one non-cash settlement instrument outcome on a future date, where the outcome of such option is contingent on (1) a payment of an option fee, and/or (2) maintaining the portfolio of assets in accordance with at least one guideline or benchmark required for the delivery of the guarantee outcome other than cash. The system comprising: a delivery of outcome module for determining delivery of a non-cash guaranteed outcome based on an assessment of an underwriting strategy associated with an asset or portfolio of assets; and a guidelines module for determining an option payment amount and at least one guideline required for the delivery of the non-cash guaranteed outcome.

The accompanying drawings, which are incorporated in and constitute a part of this specification, illustrate various embodiments of the invention and, together with the description, serve to explain the principles of the invention.

### BRIEF DESCRIPTION OF THE DRAWINGS

FIG. 1 illustrates one embodiment of a system for providing an option to convert a portfolio of assets into a guaranteed income flow at a future date.

FIG. 2 illustrates one embodiment of a method for providing an option to convert a portfolio of assets into a guaranteed income flow at a future date.

FIG. 3 illustrates one embodiment of a system for providing an option to convert a portfolio of assets into a guaranteed income flow at a future date.

FIG. 4 illustrates one embodiment of various modules associated with the option administration center of FIG. 3.

FIG. 5 illustrates one embodiment of a process flow for providing an option to convert a portfolio of assets into a guaranteed income flow at a future date.

FIG. 6 illustrates one embodiment of a process flow for providing an option to convert a portfolio of assets into a guaranteed income flow at a future date.

FIG. 7 illustrates one embodiment of a process flow for providing an option to convert a portfolio of assets into a guaranteed income flow at a future date.

### DETAILED DESCRIPTION OF THE INVENTION

Reference will now be made to the present preferred embodiments of the invention, examples of which are illustrated in the accompanying drawings in which like reference characters refer to corresponding elements.

The present invention is described in relation to a system and method for providing an option to convert an asset or portfolio of assets into a guaranteed income flow or other settlement at a future date. Nonetheless, the characteristics and parameters pertaining to the system and method may be applicable to options for converting from and to other types of financial products and services. The technical effect of the systems and methods disclosed and claimed herein is the provision of financial products and services, and more particularly, systems and methods for providing an option to convert an asset or portfolio of assets into delivery of a non-cash delivery or settlement instrument having a guaranteed income flow or other settlement at a future date.

While the exemplary embodiments illustrated herein may show the various embodiments of the invention (or portions thereof) collocated, it is to be appreciated that the various components of the various embodiments may be located at distant portions of a distributed network, such as a local area network, a wide area network, a telecommunications network, an intranet and/or the Internet, or within a dedicated object handling system. Thus, it should be appreciated that the components of the various embodiments may be combined into one or more devices or collocated on a particular node of a distributed network, such as a telecommunications network, for example. As will be appreciated from the following description, and for reasons of computational efficiency, the components of the various embodiments may be arranged at any location within a distributed network without affecting the operation of the respective system.

An aspect of the system and methods described herein is to provide to an investor an option, forward contract, futures contract, annuity or other exchange mechanism (collectively, ‘option’), whereby an asset or portfolio of assets, regardless of future performance or value, can be converted, on a future date, to a cash or non-cash settlement instrument (which may have a known and minimum guarantee), such as a financial instrument having a guaranteed income stream with possible upside.

Another aspect of the systems and methods described herein is that continuation of the option is based on: (1) payment of an ongoing premium or fee based on the value of the portfolio of assets, and/or (2) compliance with certain prescribed guideline(s) or benchmark(s).

According to the various embodiments, the systems and methods described herein to enable the issuer of the option (herein, “Counterparty”) to provide a portfolio owner with an ability to convert an asset or investment portfolio of assets into a delivery instrument at a future date. In some embodiments, an advisor or investment manager, who, as used herein, may be a registered investment advisor (“RIA”), an investment advisor representative, a registered representative of a broker dealer, a trust officer, a CPA, attorney-in-fact, or other agent, for example, managing or advising a client (e.g., asset or portfolio owner) about an asset or portfolio of assets, and who on behalf of the client, or pursuant to the client's instructions, may decide to buy the option to convert the asset or portfolio of assets, on a future date, to a delivery instrument, such as a guaranteed income flow or annuity, for example. The option may be acquired and maintained so long as payments are timely paid to the Counterparty, directly or through a trust or other acceptable arrangement. Upon conversion in the future, the Counterparty may administer the delivery instrument and coordinate its terms and payments with the portfolio owner.

In some embodiments, payments to the Counterparty to maintain the option may be made randomly or according to a predetermined schedule, such as daily, weekly, monthly, or annually, for example. In some embodiments, the payments may be assessed against the portfolio of assets, redeemed and paid to the Counterparty rather than paid directly by the asset or portfolio owner to the Counterparty.

In some embodiments, the Counterparty may monitor the advisor and/or the asset or portfolio of assets' behavior to determine if the asset or portfolio is performing adequately to support the future promised guaranteed income stream. If the conditions of the option are met, the future guarantee is not impacted. If not, the guarantee may be adjusted or eliminated. Adjustment of a guarantee may, in some embodiments, result in new guideline(s) or benchmark(s). In some embodiments, the guarantee may be accumulated over time, adjusted over time, set at a specific date or occurrence, and/or adjusted based on performance.

In some embodiments, the Counterparty can offer the option on any acceptable asset or portfolio or investment structure, which may include but not be limited to: mutual funds, separate accounts, structured products, custodial accounts, trust accounts, commingled funds, hedge funds, securities, annuities, plans (e.g., pension, 401(k), 403(b), 457 and 529), individual retirement accounts (“IRAs”), structured settlements, funding agreements, private placements, partnerships, corporations, and any other acceptable structure that may be converted to a delivery instrument according to the systems and methods described herein (any single or combination of the preceding assets or instruments hereinafter referred to as a “portfolio of assets”).

In some embodiments, the Counterparty may offer a guarantee on a portfolio of assets managed in a Mutual Fund Wrap Account. Mutual Fund Wrap Accounts currently offer a client the ability to invest a collection of mutual funds selected by their advisor or investment manager. These accounts do not offer lifetime income guarantees. In offering a product allowing the client to convert their portfolio to a lifetime guaranteed income at a future date, the Counterparty offers mutual fund wrap clients the benefit of maintaining their current investment (thus permitting the client to maintain their taxation, investment and advisory structures) while adding a guarantee component that is heretofore unavailable to mutual fund wrap clients—a lifetime guaranteed income flow. In some embodiments, the Counterparty may engage in a process that would include some or all of the following steps (or more): (1) choose portfolios on which to offer the guarantee; (2) obtain information about portfolio owner's or other individual's age, gender and/or status (e.g., marital); (3) offer the client a single or a variety of ages at which they can convert their portfolio into a guaranteed income flow; (4) monitor the ongoing performance of the portfolio; (5) adjust the guarantee based on market performance, incremental investments or distributions; (6) assess and receive fees to maintain the guarantee; (7) permit specified distributions from the portfolio; and (8) provide an income stream if and when the remaining portfolio of assets can not do so.

In some embodiments, the Counterparty could offer a guaranteed income flow to a trust or other entity administered by a State or Commonwealth in the United States for the purpose of providing prepaid primary, secondary, college or university tuition to students. For example, there are States and Commonwealths in the U.S. where a person is permitted to pay a fixed sum in one or multiple payments to the aforementioned trust or entity in advance of their child's or other named student's enrollment in a state college as a pre-payment of future tuition. In offering this program, the State or Commonwealth assumes the risk that the prepayment plus any interest or earnings from investing the pre-payment will be sufficient to pay for the student's tuition. Instead, the Counterparty could offer the State or Commonwealth a guaranteed income flow at a future date, in some embodiments the date of student enrollment. The guaranteed income flow could be based on a combination of factors including the value of the portfolio and the life expectancy of the student or students, allowing the State or Commonwealth to collect a defined stream of predictable income over the student's actual life, life expectancy or nominal life expectancy of a pool of students. This may provide advantages for the State or Commonwealth by changing their financing structure.

In some embodiments, the Counterparty in the systems and methods described herein may comprise a/an: trust, certificate corporation, corporation, limited partner, sole proprietor, partnership, limited liability corporation, collective trust, plan sponsor, custodian, bank, insurance company, broker dealer, fund company, benefit consultant, credit union, registered investment advisor, government, union, and any other individual or entity that may serve as Counterparty. In some embodiments, the delivery instruments to which the asset or investment portfolios get converted may comprise a/an: guaranteed retirement plan, various annuity types, gap insurance coverage, death benefit, period certain payouts, long-term care insurance or payments, life insurance, medicare supplement insurance, healthcare insurance, disability insurance, structured settlement, certificates of deposit, or any other instrument that may be converted from an asset or investment portfolio to guaranteed income stream or other structure prescribed by the option's terms according to the systems and methods described herein.

In some embodiments, the various systems and methods described herein permit a fee to be charged on a fluctuating value (e.g, of an asset or portfolio of assets), which fee may result in a future delivery instrument that guarantees a delivery based on how the asset or portfolio of assets is managed. In some embodiments, management of the asset or portfolio of assets may be subject to certain prescribed guideline(s) or benchmark(s). For example, to get a certain kind of delivery you need to manage this way, i.e., as long as you manage the portfolio within certain boundaries, such as, for example, making timely option payments, stay within a withdrawal limit, and/or achieve certain performance standards.

In some embodiments, the continuation of an option may be contingent on the owner ensuring the asset or portfolio of assets or other investment structure adheres to a set of criteria or investment guidelines or benchmarks. Such guidelines or benchmarks may address acceptable asset classes, asset allocations, sector limitations, diversification limitations, performance metrics or other investment criteria. In this embodiment, remedies for owner failing to adhere to guidelines may include, but not be limited to, adjustment of the guarantee, imposition of fees or fines, imposition of new guidelines or benchmarks, or termination of the option and guarantee by the Counterparty. Other remedies are of course possible.

Among many potential uses, the present invention may be used to: (1) purchase an option to exchange at a forward date a non-custodial portfolio strategy (e.g., not owned, operated or administered by the Counterparty) for a guaranteed future income stream; (2) provide for payment of the option via an ongoing portfolio value-based charge (e.g., the option owner keeps the option in-force by paying to the Counterparty an amount which is based on the value of the portfolio); (3) permit voiding of the option by the option owner by non-payment of any option premium due; and (4) delivery of the option through at least one facility, such as trust, for example.

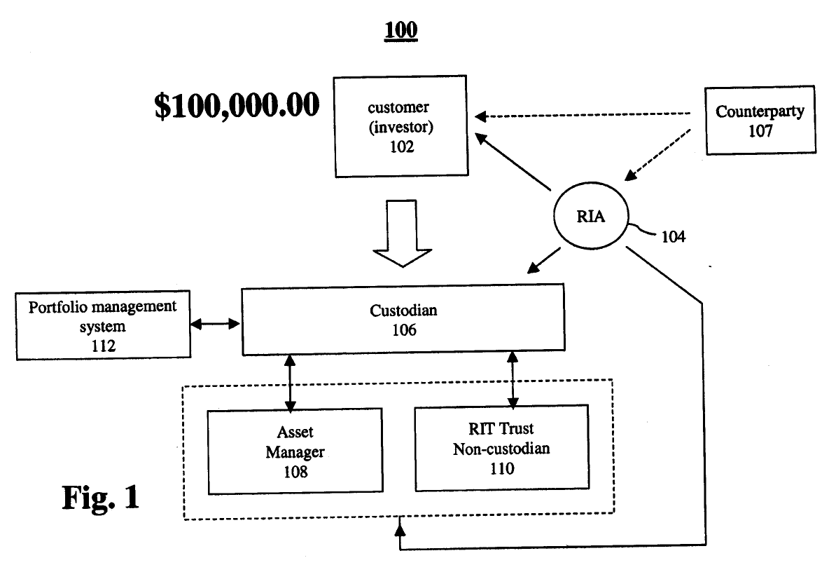

FIG. 1 illustrates one embodiment of a system 100 for providing an option to convert a portfolio of assets into a guaranteed income flow at a future date. As shown, system 100 comprises a customer or investor 102, an RIA 104 (which may or may not be utilized), a custodian (of a custodial account) 106, a Counterparty 107, an asset manager 108, a non-custodial trust 110, and a portfolio management system 112. RIA 104, if utilized, may determine the custodian 106 and asset manager 108 used in execution of customer 102's investment strategy. Counterparty 107 may offer the customer 102 and/or RIA 104 an option to convert a portfolio of assets into a guaranteed income flow at a future date. Asset manager 108 has responsibility for investment management of assets in accordance with the designated investment strategy. Portfolio Management System 112 may operate and maintain the record keeping of the custodial account. Portfolio Management System 112 may provide periodic reports on performance and other relevant information. Portfolio Management System 112 may, in some embodiments, report out the custodial account's performance. The Non-Custodial Trust 110 may comprise or operate on behalf of an intermediary to offer an option to convert a portfolio of assets into a guaranteed income flow at a future date.

As shown in FIG. 1, customer 102 invests $100,000, either directly or as advised by the RIA, into a custodial account administered by custodian 106. In some embodiments, the customer 102 relies on the RIA 104 to execute the discretionary authority to purchase different types of investments on behalf of customer 102. In some embodiments, the Non-Custodial Trust 110 provides a mechanism by which Counterparty 107 may offer the customer 102 and/or RIA 104 an option to convert the value of the customer's assets held in the custodial account, for example, into a delivery instrument (e.g., guaranteed minimum income) at a future date.

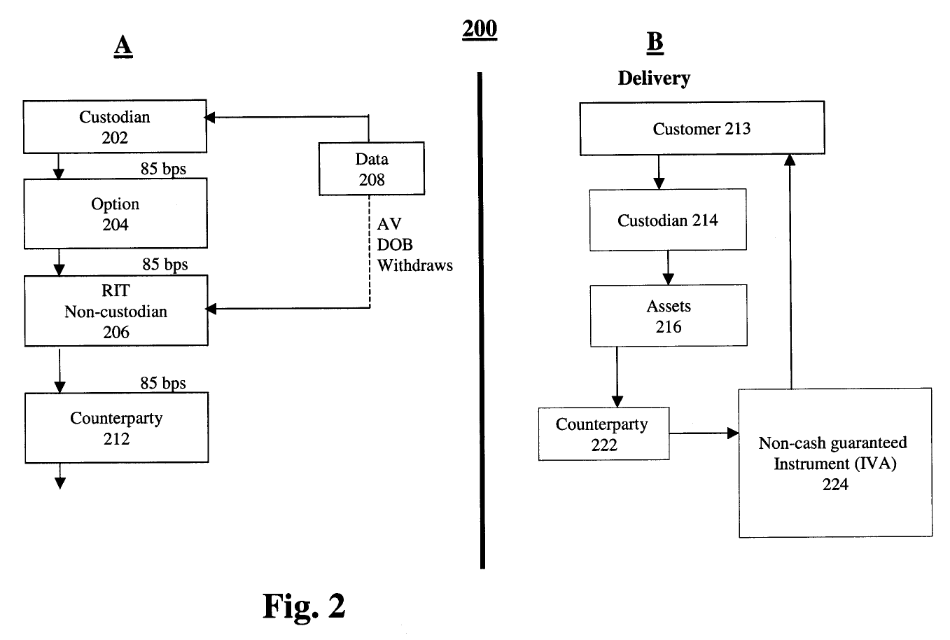

FIG. 2 illustrates one embodiment of a method 200 for providing an option to convert an asset or portfolio of assets into at least one delivery instrument having a guaranteed income flow (or some other settlement) at a future date. In some embodiments, the income flow may be determined by an appropriate formula. Process flow A describes one embodiment of a process for obtaining and maintaining an option to convert a portfolio of assets into a guaranteed income flow at a future date. Process B describes one embodiment of a process for delivery of a delivery instrument (e.g., guaranteed minimum income) to the customer 213 on the future date.

Process A proceeds as follows. First, a custodian 202 of a custodial account, for example, obtains an option 204 to convert an asset or portfolio of assets into a guaranteed income flow at a future date. The option 204 may be in the form of a forward contract, for example. In some embodiments, the option 204 may be obtained directly from the Counterparty 212 rather than through the custodian 202. To maintain the option 204, an appropriate payment(s) (e.g., 85 basis points (“bps”)) must be made, which may be paid directly or against the asset or portfolio of assets being maintained by the custodian 202. As shown, the annualized cost of buying the option 204 is based upon the assets held by the custodian 202 and expressed as a percentage of such assets. That is, in order for the option 204 to be current and the customer's ability to convert the unknown value of an asset or portfolio of assets into a future guaranteed payment stream, the payment of the option 204 premium must be maintained. In some embodiments, the cost of purchasing the option 204 is based on several factors, such as, for example, the investment strategy employed, time to conversion, payout features, and other considerations.

In some embodiments, in order for the Counterparty 212 to be able to offer and administer the option 204 there is a certain amount of data 208 that needs to be transferred from the custodian 202 to the Counterparty 212. As shown, the RIT 206 may collect, for example, information or data 208 which may comprise the current account value, date of birth of the portfolio owner, and/or transaction history. In some embodiments, the Counterparty 212 may itself collect the information or data 208. Based on a portfolio owner's transaction profile (e.g., such as contributions and withdrawals), date of birth, time to execution of the option 204 and other factors, the Counterparty 212 may develop an appropriate plan for the conversion of the investment portfolio to a delivery instrument at a future date. That is, the Counterparty 212 may determine an appropriate cost for purchasing the option 204 (e.g., 85 bps). In some embodiments, the cost of the option 204, the 85 bps, may pass through RIT (non-custodian) 206 to Counterparty 212. In some embodiments, if payment stops then the assets revert back to the previous owner and the option 204 to convert is lost. In some embodiments, the option 204 may be lost if the custodian 202 (or customer, RIA, or other portfolio manager (not shown)) fails to make payment or adhere to the guidelines that were underwritten when the option 204 was issued.

In some embodiments, data 208 transfer between the custodian 202 and the trust 206 or Counterparty 212 may occur daily, weekly, or whenever the portfolio owner transacts with the custodian 202 during the savings period. In some embodiments, in addition to transacting the funds related to the option 204 cost, for example, there may also be data exchange that may enable omnibus trading that keeps track of the information aggregated for a particular RIA and they can trade in the aggregate for all of their clients, but data will be identified at an individual level.

In some embodiments, process B illustrates the delivery of a non-cash guaranteed instrument 224 having a guaranteed income stream at a future date, e.g., when the portfolio owner reaches the age of 65. In some embodiments, the at least one delivery instrument 224 is determined by the Counterparty 222. As shown, the customer 213 causes the custodian 214 to delivery the asset or portfolio of assets 216 in exchange for a non-cash guaranteed instrument 224 at the future date. In this example, at delivery the customer 213 will get at least one delivery instrument 224 that satisfies the option conditions. In this example, the delivery instrument 224 may take the form of an immediate variable annuity with a floor guarantee equal to the guarantee prescribed in the terms of the option, or some other satisfactory delivery instrument. In some embodiments, the at least one delivery option is determined at the time the option is purchased, at conversion, or anytime in between.

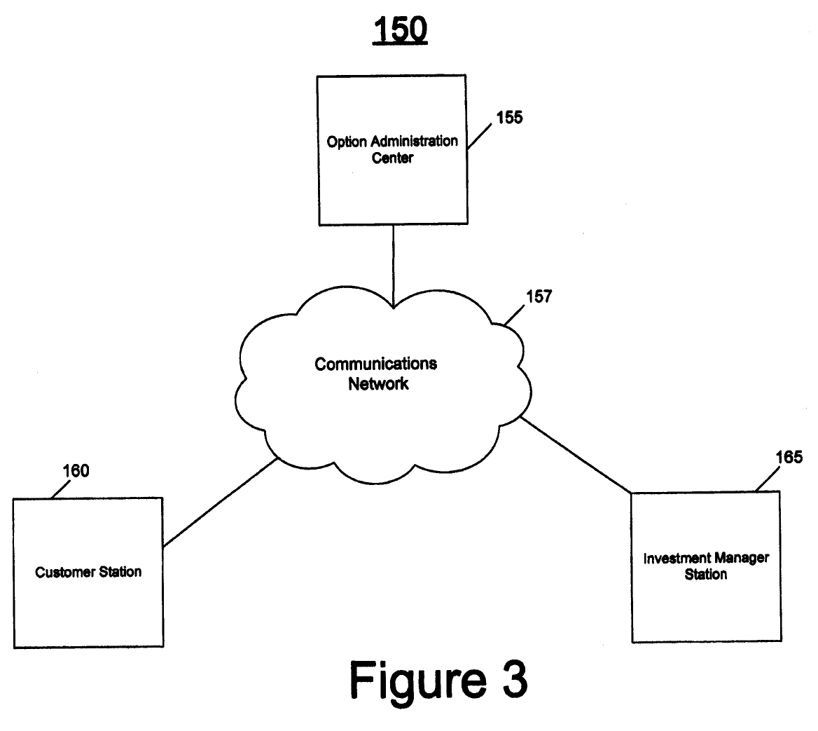

FIG. 3 illustrates one embodiment of a system 150 for issuing and managing options, according to various embodiments of the systems and methods described herein. System 150 may include an option administration center (“option center”) 155, a consumer station 160 and an investment manager station 165. The option center 155, consumer station 160 and investment manager station 165 may all be connected through communications network 157.

Option center 155 may comprise the processing station or center of an issuer of options (e.g., Counterparty), such as an investment bank, brokerage firm, insurance company or other financial institution, for example. Consumer station 160 may comprise the terminal or access point for purchasers, investors, consumers, or beneficiaries, for example. Investment manager station 165 may comprise the terminal or access point for investment managers, for example, that manage an asset or portfolio of assets that are subject to an option as described herein. Communications network 157 interconnects option center 155, consumer station 160 and investor management station 165 to enable communication and transfer of data and information. Each is described in more detail below.

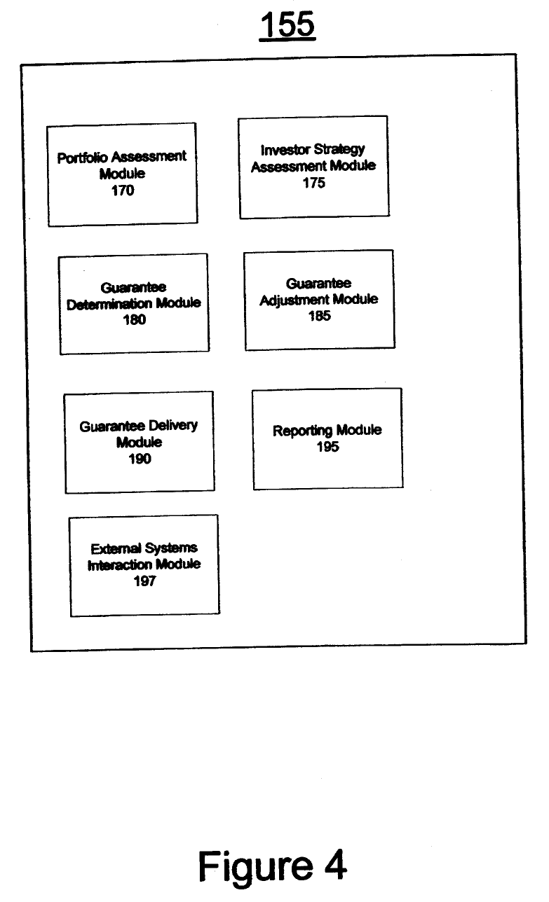

Option center 155 may comprise a single server or engine (as shown). In some embodiments, option center 155 may comprise a plurality of servers or engines, dedicated or otherwise, which may further host modules for performing the various system functionality described herein. Option center 155, for example, may host one or more applications or modules that function to permit interaction between the users (e.g., consumers/investors, option administrators, investment managers, and other parties) as it relates to the issuing and administration, for example, of options as set forth herein. For instance, option center 155 may include an administration module that serves to permit interaction between the system and the individual(s) or entity(ies) charged with administering option center 155. Option center 155 may further include module(s) for, among other things, assessing asset or portfolio particulars, such as underwriting strategy, for example. Other modules may permit users to reference option data and information, including, for example, payment due date, expected delivery date, and other like data or information (see FIG. 4 for exemplary modules that may be associated with option center 155).

Option center 155 may include, for instance, a workstation or workstations running the Microsoft Windows™ XP™ operating system, Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

Option center 155 may be operated and maintained by a Counterparty or its contract and service provider, for example, to issue options, determine delivery of a non-cash guaranteed outcome, assess assets and portfolios, monitor option payments and investment strategy, adjust and cumulate guarantees, and deliver outcome. In some embodiments, a Counterparty may comprise any individual or entity. For example, a Counterparty may comprise an individual or company/business in the financial services industry, including but not limited to, retail banks, trust companies, investment banks, broker dealers, registered investment advisors, financial advisors, CPA firms, insurance companies, mutual fund companies, hedge funds, any type of investment manager, distributors of financial products, technology providers, third party servicing firms, governmental entities, and any other individual or entity offering retirement or income plans to their employees, including but not limited to, unions, and companies with pension plans or defined contribution plans, for example.

Consumer stations 160 may be used by a consumer, invest, option purchaser or buyer, for example to interface with option center 155 and input information or data in connection with purchasing, maintaining or converting an option, for example. In one embodiment, for example, a consumer may interface with a graphical user interface (or GUI), for example, to input data and information through a predetermined form that queries for desired particulars on retirement, such as expected retirement date, benefits desired and length of benefit period, and assets or portfolio to be guaranteed, for example. In some embodiments, consumer station 165 may be used to make option payments to the issuer of the option.

Investor management stations 165 may be used by a manager of an investment fund, for example to interface with option center 155 input information or data in connection with purchasing an option. In one embodiment, for example, an investment manager may interface with a graphical user interface (or GUI), for example, to input information through a predetermined form that queries for desired particulars on retirement, such as expected retirement date, benefits desired and length of benefit period, and assets or portfolio to be guaranteed, for example.

Consumer and investor management stations 160 and 165 may comprise or include, for instance, a personal or laptop computer running a Microsoft Windows™ 95 operating system, a Windows™ 98 operating system, a Millenium™ operating system, a Windows NT™ operating system, a Windows™ 2000 operating system, a Windows XP™ operating system, a Windows CE™ operating system, a PalmOS™ operating system, a Unix™ operating system, a Linux™ operating system, a Solaris™ operating system, an OS/2™ operating system, a BeOS™ operating system, a MacOS™ operating system, a VAX VMS operating system, or other operating system or platform. Consumer and investor management stations 160 and 165 may include a microprocessor such as an Intel x86-based or Advanced Micro Devices x86-compatible device, a Motorola 68K or PowerPC™ device, a MIPS device, Hewlett-Packard Precision™ device, or a Digital Equipment Corp. Alpha™ RISC processor, a microcontroller or other general or special purpose device operating under programmed control. Consumer and investor management stations 160 and 165 may further include an electronic memory such as a random access memory (RAM) or electronically programmable read only memory (EPROM), a storage such as a hard drive, a CDROM or a rewritable CDROM or another magnetic, optical or other media, and other associated components connected over an electronic bus, as will be appreciated by persons skilled in the art. Consumer and investor management stations 160 and 165 may be equipped with an integral or connectable cathode ray tube (CRT), a liquid crystal display (LCD), electroluminescent display, a light emitting diode (LED) or another display screen, panel or device for viewing and manipulating files, data and other resources, for instance using a graphical user interface (GUI) or a command line interface (CLI). Consumer and investor management stations 160 and 165 may also include a network-enabled appliance such as a WebTV™ unit, a radio-enabled Palm™ Pilot or similar unit, a set-top box, a browser-equipped or other network-enabled cellular telephone, or another TCP/IP client or other device.

Communications network 157 may be comprised of, or may interface to any one or more of, the Internet, an intranet, a Personal Area Network (PAN), a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1 or E3 line, a Digital Data Service (DDS) connection, a Digital Subscriber Line (DSL) connection, an Ethernet connection, an Integrated Services Digital Network (ISDN) line, a dial-up port such as a V.90, a V.34 or a V.34bis analog modem connection, a cable modem, an Asynchronous Transfer Mode (ATM) connection, a Fiber Distributed Data Interface (FDDI) connection, or a Copper Distributed Data Interface (CDDI) connection. Communications network 215 may also comprise, include or interface to any one or more of a Wireless Application Protocol (WAP) link, a General Packet Radio Service (GPRS) link, a Global System for Mobile Communication (GSM) link, a Code Division Multiple Access (CDMA) link or a Time Division Multiple Access (TDMA) link such as a cellular phone channel, a Global Positioning System (GPS) link, a cellular digital packet data (CDPD) link, a Research in Motion, Limited (RIM) duplex paging type device, a Bluetooth radio link, or an IEEE 802.11-based radio frequency link. Communications network 215 may further comprise, include or interface to any one or more of an RS-232 serial connection, an IEEE-1394 (Firewire) connection, a Fibre Channel connection, an infrared (IRDA) port, a Small Computer Systems Interface (SCSI) connection, a Universal Serial Bus (USB) connection or another wired or wireless, digital or analog interface or connection.

Communications network 157 may be used by a user of consumer station 160 or investment manager station 165, or an administrator of option center 155, for example, to transmit or receive data or information relating to the issuance, purchasing, processing and monitoring of options, assets, portfolios and investment strategies. For instance, a consumer or investment manager may electronically submit information to an issuer in connection with the purchase of an option, for example. Similarly, an administrator of option center 155 may use communications network 157 to transmit periodic reports to owners of options, interface with various external systems in connection with the various features and functionality described herein, or to process payments made in connection with options, for example. Other uses of communications network 157 are of course possible.

FIG. 4 illustrates exemplary modules that may be associated with option administration center 155 for carrying out (or administering) the various functions and features of the embodiments described herein. In some embodiments, option center 155 may comprise a portfolio assessment module 170, an investor strategy module 175, a guarantee determination module 180, a guarantee adjustment module 185, a guarantee delivery module 190, a reporting module 195, and an external systems interaction module 197. Other modules for performing the various and features and functionality of the systems and methods described herein may be provided. While the modules may not be used in all embodiments to perform some or all of the functions of the present invention, they are nonetheless presented as possible embodiments:

Portfolio assessment module 170 may, in some embodiments, assess an option purchaser's asset or portfolio on which the option will be issued. In some embodiments, a portfolio assessment is performed in advance to determine if a guarantee is to be offered. In some embodiments, the assessment may be based on specified benchmarks that the Counterparty is comfortable with. For example, the asset or portfolio of assets is assessed to ensure that it is in alignment with what the Counterparty believes over time will meet a required risk and return profile.

Investor strategy assessment module 175 may, in some embodiments, assess the investment or underwriting strategy of an investment manager that is managing the option purchaser's asset or portfolio of assets. For example, the performance of the asset or portfolio of assets may provide a reliable indicator of how successful the manager has been in realizing gains on the assets or portfolio of assets. Similarly, the decisions taken by the manager in the past may also demonstrate the manager's effectiveness. In some embodiments, the assessment(s) by portfolio assessment module 170 and investor strategy assessment module 175 may be performed on a quantitative and qualitative basis. From a quantitative perspective, the Counterparty can look at investments and stated investment goals. From a qualitative perspective, the Counterparty can look at the experience of the investment manager or management team, the volume of business that they are doing, what controls they have in place for controllership, the validity of the information they use, and the transparency of the decisions that they make regarding investment strategies, for example.

In some embodiments, portfolio assessment module 170 and investor strategy assessment module 175 may then take the available information and determine that the portfolio and/or investment strategy is slightly different than a particular benchmark, but they have good controls, experienced people and demonstrated good performance, for example, that indicate a reasonable outlook or strategy on the future economy and more particularly the ability of the asset or portfolio of assets to successfully perform in the future.

Guarantee determination module 180 may, in some embodiments, determine a guaranteed delivery based, for example, on the portfolio assessment and the investment strategy assessment. In some embodiments, the guarantee delivery may be lifetime stream of income or other settlement. The better the portfolio rating and/or performance, the higher the guarantee that can be made. For example, if the portfolio assessment demonstrates that the asset or portfolio of assets contains a reliable mix of assets and the investment manager has a proven track record, then the guarantee associated with the purchased option would be higher than if the track record were simply fair, for example. In some embodiments, guarantee determination module 180 may also determine an option payment that the purchaser of the option must pay (e.g. in cash or in kind) in order to keep the option in effect. The amount of the option payment may be based on the result of the portfolio and investment strategy assessments. In some embodiments, portfolio assessment module 170 and investor strategy assessment module 175 operate on the basis of parameters or rules against which information regarding the asset, portfolio of assets or investment manager or team is resolved. Parameters or rules can be quantitative or qualitative in nature.

For example, two portfolios under the control of two different investment managers consistently out-performs the S&P 500 for the last five (5) years. However, if one of the investment managers fails to comply with a prescribed guideline, for example, the Counterparty may decide against underwriting or continuing to underwrite the guarantee or option, or may provide conditions or guidelines with such guarantee or option. In some embodiments, guarantee determination module 180 may also determine investment guidelines or benchmarks that the investment manager associated with the asset or portfolio of assets must stay within in order for the option remain in effect. For example, the investment manager could be required to outperform the S&P 500 or other index. In some embodiments, guidelines or benchmarks may be imposed on the purchaser/consumer/investor. For example, the purchaser/consumer/investor may be limited to a maximum withdrawal of cash from the asset or portfolio of assets in order for the guarantee to persist. Similarly, the option payment must be timely received by the Counterparty in order for the guarantee to remain in effect. Other guidelines are of course possible.

Guarantee adjustment module 185 may, in some embodiments, perform an ongoing valuation or appraisal of the asset, portfolio of assets and/or investment manager strategy, for example, to determine whether the guarantee determined by guarantee determination module 180 should still be offered, whether a higher guarantee should be offered, or whether a lower guarantee should be offered. In some embodiments, such ongoing valuations may occur randomly, periodically (e.g., daily, weekly, monthly, annually, etc.). In some embodiments, guarantee adjustment module 185 may monitor, for example, whether option payments are being made in a timely manner and whether the investment manager is staying within the prescribed guidelines. Monitoring may occur on a periodic basis (e.g., daily, weekly, monthly or annually), randomly, or according to a particular schedule. In some embodiments, guarantee adjustment module 185 may prospectively adjust the guarantee to reflect any fluctuations in the performance of or changes in the asset or portfolio of assets. In some embodiments, if a monitored asset or portfolio of assets fails to stay within the prescribed guidelines, for example, the investor or investment manager may be fined (e.g., a reduction in the guarantee, a payment or combination of both). For example, assume a guarantee has guideline or benchmark requiring the asset or portfolio of assets to outperform the S&P 500. Assume that the S&P 500 goes up 10% in the coming year, but the asset or portfolio of assets only goes up 8%. In such a case, the Counterparty may require the investment manager, for example, to pay a fine (e.g., a percentage of the current value of the portfolio) every month (or other appropriate cycle) until the performance gains go above the benchmark. If, however, the asset or portfolio of assets continues to under-perform, then the Counterparty may prospectively reduce or eliminate the guarantee. In some embodiments, an adjustment of a guarantee may result in the imposition of new guidelines or benchmarks that must be met for the adjusted guarantee to remain in effect. If, however, the asset or portfolio of assets outperforms the S&P 500, then the guarantee may pay the investor or investment manager a bonus. The business rules upon which guarantees are adjusted or eliminated may be determined with the investor or investment manager when the guarantee is first determined and offered.

In some embodiments, the Counterpary may permit the purchaser/consumer/investor to withdraw a certain amount of money out of their asset or portfolio of assets without penalty. So long as the purchaser/consumer/investor stays within the permitted withdrawals, then the guarantee will remain in effect, even if the portfolio does not sustain the withdrawal. In such a case, therefore, the purchaser/consumer/investor will not run out of money because the Counterparty will provide the guarantee (at its current valuation) upon taking that last remaining amount of money remaining in the account associated with the asset or portfolio. For example, if the purchaser/consumer/investor is permitted to withdraw $100 a month from his account, and in so doing dwindles his account balance on the asset or portfolio of assets down to $90, then—assuming all other guidelines and benchmarks have been met—the Counterparty may take the $90 and at that moment convert the option to delivery instrument. However, if the purchaser/consumer/investor withdraws beyond the limit, then the guarantee may be adjusted downward or eliminated outright. In some embodiments, guarantee adjustment module 185 may also accumulate the guarantee if the purchaser has made additional payments or contributions to the asset or portfolio of assets.

Guarantee delivery module 190 may, in some embodiments, deliver the guarantee that persists at the time the delivery date arrives. In some embodiments, the delivery date is determined based on a date determined by the purchaser at the time the option is purchased, such as a planned retirement date, for example. In some embodiments, the delivery date may be determined based on when the purchaser, by virtue of making withdrawals against the asset or portfolio of assets, has just enough money to make a final option payment, at which point the portfolio may be converted into a delivery instrument providing a guaranteed income stream or other settlement. In this scenario, so long as the purchaser/consumer/investor and/or investment manager complied with the requisite guidelines or benchmarks, then the Counterparty will start paying the guarantee as agreed, or as adjusted just prior to the conversion.

In some embodiments, guarantee delivery module 190 may also perform the functionality related to converting the asset and portfolio of assets to a delivery instrument that provides an income stream. In some embodiments, the particular instrument is determined by option center 155, while in some embodiments it is selected by the purchaser of the option at the time of purchase, at delivery, or any other time. In some embodiments, the delivery instrument may comprise a plurality of delivery instruments.

Reporting module 195 may, in some embodiments, report particulars about the various features and functionality described herein to purchaser/investors, investment managers and or option center 155 administrators. For example, reporting module 195 may provide an option purchaser with particulars on the option payment schedule, value of the asset or portfolio of assets, or any other data or information that may be relevant to the purchaser's interest in the option.

External systems interaction module 197 may, in some embodiments, interact or communicate with various external proprietary record-keeping systems. For example, an administrator of option center 155, for example, may provide option-related information to the reporting systems of banks or other financial institutions. In some embodiments, external systems interaction module 197 may also receive data or information that is electronically submitted by such external rule or regulatory system(s). In this way, the various features and functionality described herein can cooperate with the various systems and methods of various financial institutions in providing services and products to consumers.

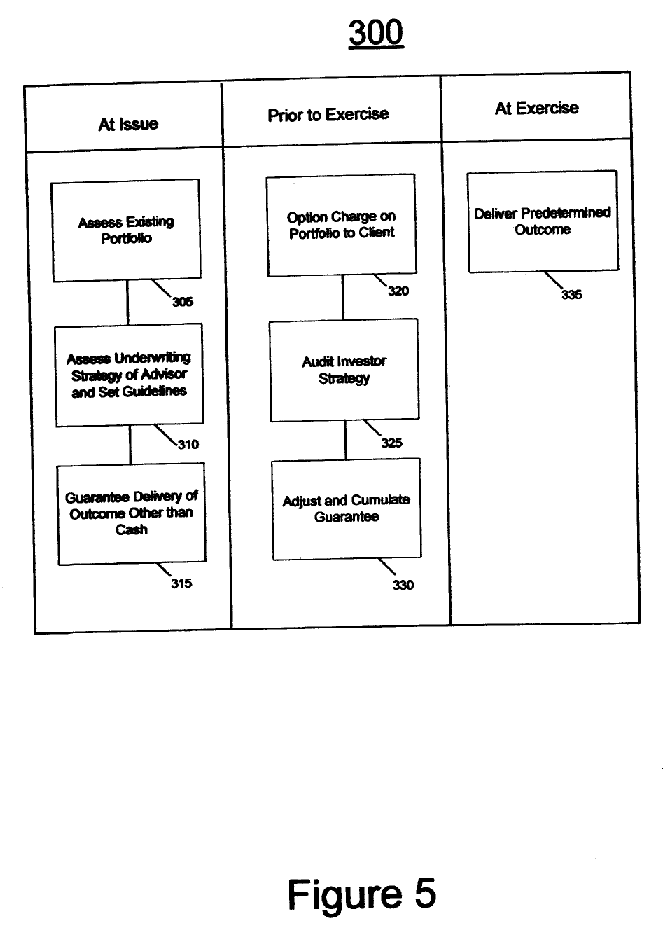

FIG. 5 illustrates one embodiment of a method 300 for providing an option to convert a portfolio of assets into a guaranteed income flow at a future date. As shown, there are three phases to the various features and functionality described herein for issuing an option to convert an asset or portfolio of assets into a guaranteed income flow at a future date. Those phases are: (1) issuance of the option, (2) the period of time after issuance but prior to exercise of the option, and (3) at exercise of the option. Each phase is associated with particular sub-steps. The at-issue phases, for example, is associated with three steps. At step 305, the particular asset or portfolio of assets is assessed. At step 310, the underwriting strategy of the advisor or investment manager is assessed and a set of performance guidelines are established that the advisor or investment manager must abide by in order to keep the option in effect. Next, at step 315, a delivery of a non-cash guaranteed outcome is communicated to the purchaser.

The next phase is the period of time following issuance but before exercise of the option. This phases also has three sub-steps. At step 320, the option payment is charged to the asset or portfolio of assets. In some embodiments, the payment is charged periodically. At step 325, the advisor or investment manager's strategy on the asset or portfolio of assets is audited to ensure that it is staying with the prescribed guidelines. At step 330, the guarantee may be adjusted or cumulated. For example, if the payment is timely made and the guidelines are met, then the guarantee remains in effect. If not, the option may be terminated or adjusted accordingly. In some embodiments, the guarantee may be cumulated if the asset or portfolio of assets realized gains or the purchaser contributed thereto.

The last phase is reflected in step 335 and comprises exercise of the option, or delivery of the predetermined outcome. In some embodiments, the purchaser of the option may decide to convert the asset or portfolio of assets into at least one delivery instrument that provides a guaranteed income flow. At conversion, therefore, the purchaser of the option may be given the choice to select one or more delivery instruments that meet the guaranteed income flow. In some embodiments, the purchaser of the option may select the at least one delivery instrument at the time the option is purchased or anytime prior to conversion. In some embodiments, the at least one delivery instrument may be determined by the Counterparty at the time the option is purchased, at conversion or anytime in between.

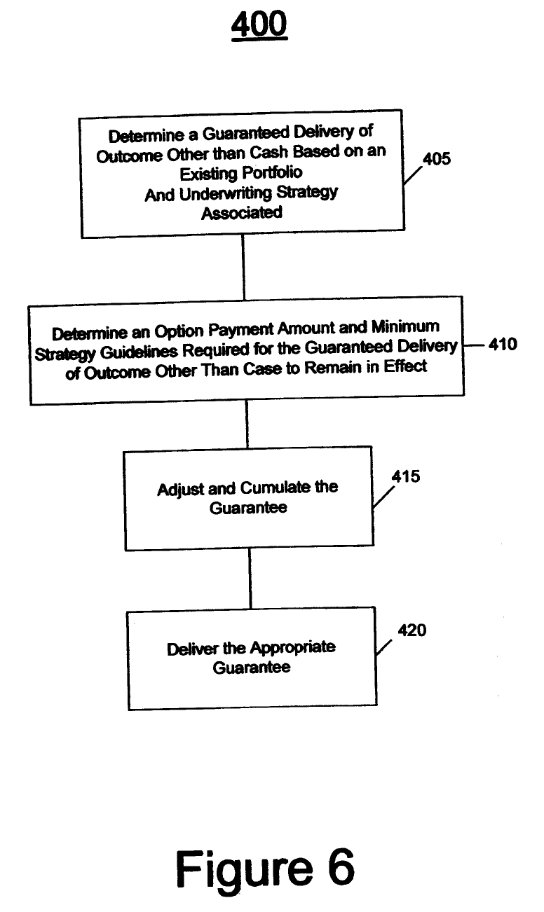

FIG. 6 illustrates one embodiment of a method 400 for providing an option to convert a portfolio of assets into a guaranteed income flow at a future date. At step 405, a delivery of a non-cash guaranteed delivery outcome is determined based on an existing portfolio and underwriting strategy associated therewith. At step 410, an option payment amount and minimum strategy guidelines required for the guaranteed delivery of outcome to remain effective are determined. At step 415, the guarantee is adjusted and cumulated. In some embodiments, steps 410 and 415 may be repeated multiple times. At step 420, the appropriate guarantee is delivered.

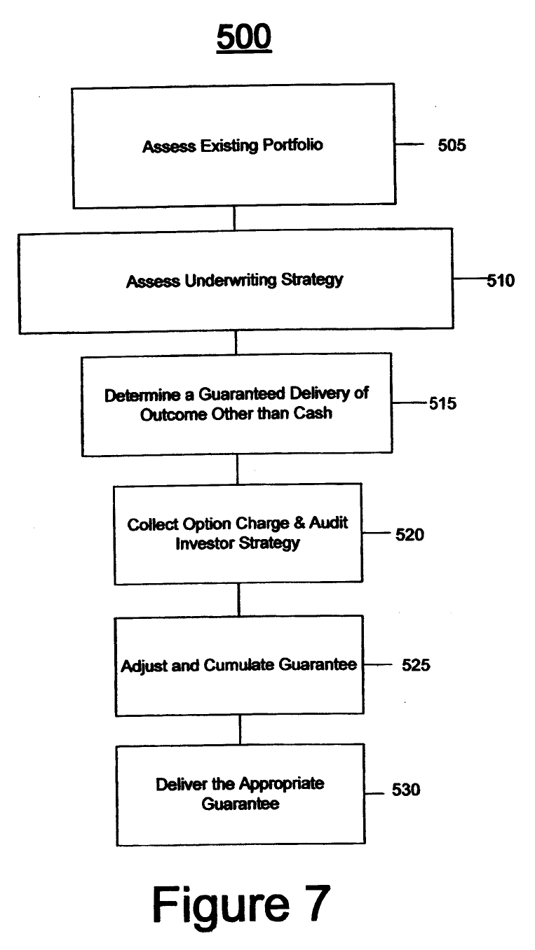

FIG. 7 illustrates one embodiment of a method 500 for providing an option to convert a portfolio of assets into a guaranteed income flow at a future date. At step 505, an existing portfolio is assessed. At step 510, an underwriting strategy of the portfolio is assessed. At step 515, a delivery of a non-cash guaranteed outcome is determined. At step 520, an option payment is collected and the investor strategy is audited to ensure compliance with guidelines. At step 525, adjust and cumulate the guarantee. At step 530, the appropriate guarantee is delivered.

Other embodiments, uses and advantages of the present invention will be apparent to those skilled in the art from consideration of the specification and practice of the invention disclosed herein. The specification and examples should be considered exemplary only. The intended scope of the invention is only limited by the claims appended hereto.

1. A method for providing an investor the ability to purchase an option to exchange a future value of an asset or a portfolio of assets, regardless of future performance or value, for at least one non-cash settlement instrument outcome on a future date, where the outcome of such option is contingent on (1) a payment of an option fee, and/or (2) maintaining the portfolio of assets in accordance with at least one guideline or benchmark required for the delivery of the non-cash guaranteed outcome, the method comprising:
determining a delivery of the non-cash guaranteed outcome based on an assessment of an underwriting strategy associated with an asset or portfolio of assets; and
determining an option payment amount and at least one guideline required for the delivery of the non-cash guaranteed outcome.

2. The method of claim 1 wherein the assessment of an underwriting strategy comprises an assessment of the asset or portfolio of assets and an assessment of the investment manager's strategy.

3. The method of claim 1 wherein the option payment amount and the at least one guideline or benchmark is based on the assessment of the underwriting strategy.

4. The method of claim 1 wherein the option payment is made by the investor or an investor agent to a Counterparty directly or through a trust or other acceptable arrangement.

5. The method of claim 4 wherein the Counterparty may comprise a/an trust, certificate corporation, corporation, limited partner, sole proprietor, partnership, limited liability corporation, collective trust, plan sponsor, custodian, bank, insurance company, broker dealer, fund company, benefit consultant, credit union, registered investment advisor, government or union.

6. The method of claim 1 wherein the asset or portfolio of assets comprises any acceptable portfolio or investment structure(s), mutual fund(s), separate account(s), structured product(s), custodial account(s), trust account(s), commingled fund(s), hedge fund(s), individual security(ies), structured settlement(s), private placement(s), partnership(s), corporation(s), or other acceptable structure that may be converted pursuant to the terms of the option.

7. The method of claim 1 wherein the delivery of the non-cash guaranteed outcome comprises a variable annuity contract with a floor equal to the guaranteed income stream amount.

8. The method of claim 1 wherein the option fee is based in part on the current value of the asset or portfolio of assets.

9. The method of claim 1 further comprising the step of conducting an ongoing valuation or appraisal of the guarantee by assessing compliance with the at least one guideline or benchmark.

10. The method of claim 9 wherein the guaranteed delivery of outcome other than cash is increased based on compliance with the at least one guideline or benchmark and the performance of the asset or portfolio of assets.

11. The method of claim 9 guarantee can decrease based on failure to comply with the at least one guideline or benchmark.

12. The method of claim 9 wherein the ongoing valuation or appraisal is conducted periodically.

13. The method of claim 9 further comprising the step of permitting remedies and corrective actions to continue to guarantee.

14. The method of claim 1 wherein the investor determines the at least one non-cash settlement instrument.

15. The method of claim 14 wherein the investor can add additional non-cash settlement instruments prior to or at conversion.

16. The method of claim 14 wherein the investor can cancel the option with or without penalties or additional charge.

17. The method of claim 1 wherein the guarantee is contingent on one or more lives.

18. The method of claim 1 wherein the underwriting guidelines can change on a future date.

19. The method of claim 1 wherein the guarantee can be transferred from one asset or portfolio of assets to another.

20. The method of claim 1 wherein the option payment can be funded by the investor or any other party.

21. The method of claim 1 wherein the option payment can be factored from the portfolio or the future payments or settlement options.

22. The method of claim 1 wherein the guaranteed outcome is be based on a formula that considers on the age and/or gender of the owner.

23. The method of claim 1 wherein the at least one settlement instrument results in a cash flow.

24. The method of claim 1 wherein the at least one settlement instrument results in a non-cash transaction.

25. The method of claim 1 wherein the at least one settlement instrument results in the portfolio of assets being transferred to a Counterparty as a remedy or as the purchase settlement option.

26. The method of claim 1 wherein the initial underwriting process determines the at least one settlement instrument.

27. The method of claim 1 wherein the investor or recipient of the guarantee is an individual or public, private entity.

28. The method of claim 1 wherein the recipient of the guarantee outcome other than cash is someone other than the investor.

29. The method of claim 1 wherein the at least one settlement instrument comprises two or more settlement instruments.

30. The method of claim 1 further comprising the step of interfacing with at least one external recordkeeping system.

31. A method for providing an option to exchange a future value of a portfolio of assets, regardless of future performance or value, for at least one non-cash settlement instrument outcome on a future date, comprising:
assessing an existing portfolio;
assessing an underwriting strategy associated with the portfolio;
determining a guaranteed delivery of outcome other than cash based on the portfolio and underwriting assessments;
issuing an option to exchange a future value of the portfolio, regardless of future performance or value, for at least one non-cash settlement instrument outcome on a future date;
collecting an option payment; and
auditing the investment strategy of the of portfolio.

32. A method for providing an option to exchange a future value of a portfolio of assets, regardless of future performance or value, for at least one non-cash settlement instrument outcome on a future date, comprising:
determining a guaranteed delivery of outcome other than cash based on an existing portfolio and an underwriting strategy associated with the portfolio;
determining an option payment amount and minimum strategy guidelines required for the guaranteed delivery of outcome other than cash to remain in effect;
adjust and cumulate the guarantee; and
deliver the appropriate guarantee.

33. A system for providing an investor the ability to purchase an option to exchange a future value of an asset or a portfolio of assets, regardless of future performance or value, for at least one non-cash settlement instrument outcome on a future date, where the outcome of such option is contingent on (1) a payment of an option fee, and/or (2) maintaining the portfolio of assets in accordance with at least one guideline or benchmark required for the delivery of the least one non-cash settlement instrument outcome, the system comprising:
a delivery outcome module for determining the delivery of a non-cash guaranteed outcome based on an assessment of an underwriting strategy associated with an asset or portfolio of assets; and
a option payment and guidelines module for determining an option payment amount and at least one guideline required for the delivery of the non-cash guaranteed outcome.
